(19) United States
(12) Patent Application Publication
(10) Pub. No.: US 2002/0006187 A1
(43) Pub. Date: Jan. 17, 2002

(54) Method and system for recording communication data

(76) Inventor: Guenter Lukas, Oberzoegersdorf (AT)

Correspondence Address: Bell, Boyd & Lloyd LLC, P.O. Box 1135, Chicago, IL, 60690, US

(21) Appl. No.: 09/836,724

(22) Filed: Apr. 17, 2001

(30) Foreign Application Priority Data
Apr. 17, 2000 (DE) 100 19 001.4

(51) Int. Cl. H04M 1/64

(52) U.S. Cl. 379/67.1

(57) ABSTRACT

A system and method for recording communication data between two communicating users, wherein a switching system is controlled by the recording system via a CTI interface, and instructed to pass digital data directly to the recording system via an S0 interface, provided a connection is established between two of the users to be monitored. Since the communication data is transferred in digital format, it is beneficial to store this data directly on the hard disk of a PC. It is also beneficial if control of the switching equipment is undertaken entirely by the PC for the purposes of call recording.

### BACKGROUND OF THE INVENTION

1. Field of the Invention

The present invention relates to a method and system for recording communication data, particularly voice data, that is transferred on a communication connection established by a switching system.

2. Description of the Prior Art

Within the market for telecommunication products, there is a significant requirement for devices that can record telephone calls, so that they can be logged and analyzed in many different ways. This is evident from the numerous different products available on the market that are designed specifically for this segment. There are call-logging devices that are controlled by switching equipment and have analog inputs for user call signals, for example. Such devices can communicate with the switching equipment via a CTI interface and control signals, for example, in order to be activated and deactivated by the switching equipment. Magnetic tapes or other recording media can be used within the devices for recording purposes.

More recent products on the market are able to digitize incoming analog call signals and store them on the magnetic disk of a personal computer. Such devices are also available with a CTI interface, over which control commands can be exchanged with the associated switching equipment. The MTP8PCI plug-in card is an example of such a product, and it is part of the Passport-PCI series from the manufacturer Music Telecom.

State-of-the-art recording systems generally have the disadvantage that they must receive the communication signals directly and in analog format, and that control of a recognized recording device must be initiated by the switching equipment.

An object of the present invention, therefore, is to define a method and system for the recording of communication data, wherein the known disadvantages of state-of-the-art systems are avoided.

### SUMMARY OF THE INVENTION

Accordingly, pursuant to the inventive method, communication data is forwarded to the recording equipment in digital format via a digital interface. This eliminates the line overheads involved in providing analog connections to the recording equipment, and the associated analog/digital conversion stage required to allow digital recording on the hard disk of a personal computer, for example.

In an embodiment, the method is enhanced so that it does not record all the communication data generated on all connections established via the switching equipment, but only communication data from communication connections that have been defined in advance. This ensures that storage space in the recording equipment is used economically, and that the digital data stream via the digital interface between the switching equipment and the recording equipment remains within limits.

In another embodiment, the method is enhanced so that data recording is controlled by the recording equipment. As such, for example, the recording equipment monitors communication connections established via the switching equipment. If a communication connection that requires monitoring is established, then the recording equipment controls the switching equipment in such a way that the relevant communication data is routed to itself.

In a further embodiment, the method is enhanced so that the recording equipment controls the switching equipment via a CTI connection link, because standardized transmission protocols are available for CTI interfaces and the implementation overheads for establishing a control system are therefore low.

In another embodiment, the method is enhanced so that the call data is recorded in digitized format because communication connections often take the form of call connections. There is, therefore, a significant requirement for recording connections of this type. Another reason for the call data to be recorded in digitized format is that digitized speech can be compressed easily using standard methods to ensure optimum utilization of the storage space on a magnetic disk.

It is particularly beneficial if the system of the present invention includes two communication stations, one switching system, one recording system and one control system, where the digital data from a communication connection between the two stations is routed to the recording system for digital recording via a digital interface, under the control of the control system. Such a configuration provides a new type of facility for recording communication data with a low level of technical and hardware overheads.

In an embodiment, the system is enhanced to include an S0 interface since this is a standardized interface that can transfer digital communication data. This minimizes the overheads for linking the recording equipment for digital communication data, since standardized products can be used.

In another embodiment, the system is enhanced to include a CTI connection between the switching equipment and the recording equipment, because the switching equipment can be controlled by the recording equipment via the CTI connection, and standardized protocols can be used between the recording equipment and the switching equipment via the CTI connection. As such, no additional load is placed on the processor of the switching equipment as a result of recording the communication data. The processor is therefore able to perform its other tasks more efficiently.

In a further embodiment, the recording equipment controls the switching equipment, for the purposes of recording the communication data, via a control system that is located in the recording equipment, and which causes communication data to be forwarded for specific connections that have to be logged. With this type of equipment configuration, the recording equipment takes responsibility for monitoring communication connections and for control functions, and this produces a maximum reduction in the load on the processing units in the switching equipment.

In yet another embodiment, the system is enhanced so that the recording equipment is implemented in the form of a PC, since PCs are available at low cost on the market and are ideally suited to the recording of digital communication data. Furthermore, they are based on the principle of digital processing and include a magnetic recording medium in the form of a hard disk, which can be used to record communication data.

Furthermore, another embodiment of the system is enhanced so that the PC includes a network interface, so that digital communication data can be input to the network or retrieved from the network respectively. This provides a distributed configuration for recording and reproduction, which offers a high level of redundancy, and therefore failure protection, and does not require significant additional overheads for its implementation.

Additional features and advantages of the present invention are described in, and will be apparent from, the Detailed Description of the Preferred Embodiments and the Drawings.

### DESCRIPTION OF THE DRAWINGS

FIG. 1 shows a state-of-the-art recording system;

FIG. 2 shows an example of the equipment configuration for inventive recording system; and

FIG. 3 shows an example of a communication model when the inventive method is applied.

### DETAILED DESCRIPTION OF THE PREFERRED EMBODIMENTS

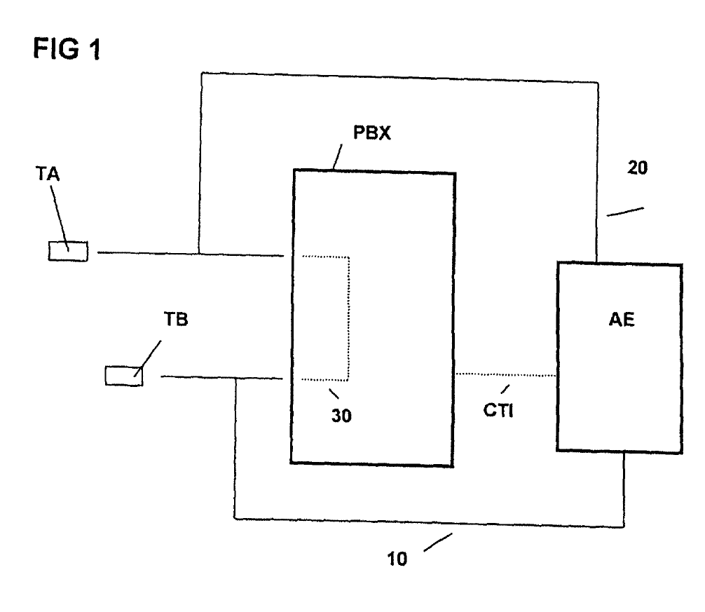

As shown in FIG. 1, a state-of-the-art recording system consists of two users and their allocated user terminal devices TA and TB, together with a switching system PBX, which provides a communication connection 30 between the communication users TA and TB. This equipment configuration also includes recording equipment AE, which can be connected to the users, or their terminal devices TA and TB, via analog link lines 10 and 20. The recording equipment AE can be controlled by the switching system PBX via a control line CTI, in order to implement an analog recording of the analog communication signals between TA and TB.

This type of equipment configuration has the disadvantage that communication data only can be recorded if there is an analog connection between the user terminal devices and the recording equipment. As such, it is only possible to monitor a limited number of users, and that significant hardware overheads are required for the recording of communication data.

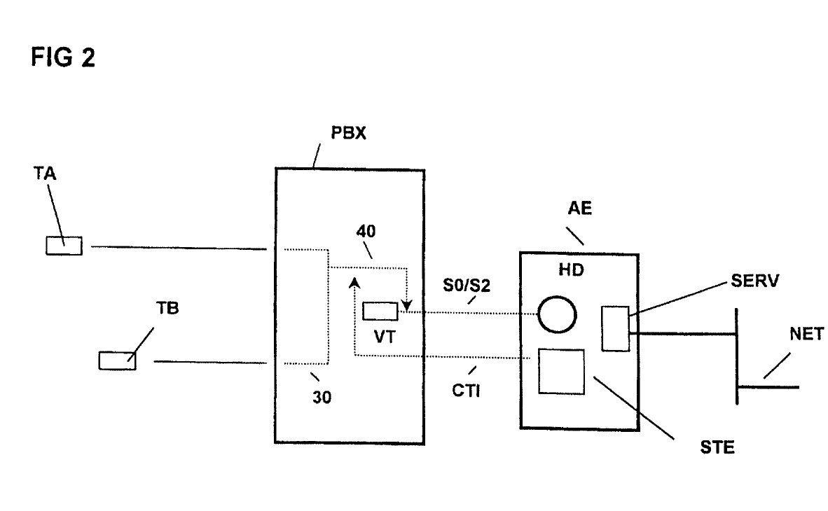

FIG. 2 shows an implementation example of the system for recording and reproduction in accordance with the teachings of the present invention. Although there are numerous potential users and associated terminal devices, only users TA and TB (or their respective terminal devices) are shown here. The other main components are the switching equipment PBX and the recording equipment AE.

A communication connection between the users TA and TB is established via the switching equipment PBX. This communication connection 30 is used to carry digital communication data. It should be noted in this context that the communication connection 30 is not restricted to only providing a communication connection between fixed-network terminal devices. On the contrary, any combination of fixed-network and mobile terminal devices can be supported, provided they exchange digital communication data that can be routed via the switching equipment PBX.

A CTI connection CTI is shown between the switching equipment PBX and the recording equipment AE. This ensures that control commands can be transferred between the switching equipment and the recording equipment. These control commands are used to start and stop recording whenever there is a requirement to record communication data, or to determine whether a communication connection 30 has been established on which communication data should be recorded. The CTI connection provides a common, standardized connection, which also can be used to support proprietary protocols. CSTA (Computer Supported Telephone Integration) is one example of such a proprietary protocol.

In order to start a recording operation, there has to be a control system that issues a command via the CTI interface to initiate the recording operation or a reproduction operation respectively. In this case, the control system STE is located in the recording equipment, because this type of configuration has the advantage that the processing unit in the switching equipment PBX does not have to cope with the additional load of control and analysis operations. However, it is also conceivable for the control system to run as a process in a central processing unit in the switching equipment PBX. There is a further interface S0/S2 between the switching equipment PBX and the recording equipment, which allows the transfer and storage of digital communication data; e.g., to a magnetic disk HD in the recording equipment. A network access SERV is also shown in this model, so that the recording equipment AE can connect to a communication network or data network NET.

This would allow the recording of data from calls that take place via the data network NET, for example, or the input of recorded communication data from the hard disk HD to the network. If necessary, it also would be possible for the recording equipment to input incoming digital communication data from the interface S0/S2 to the data or communication network NET, where this data could then be processed further or stored by other equipment in the network NET.

If there is only a requirement to monitor a limited number of communication connections 30, then a list of user-specific information can be provided for the recording equipment, by identifying the relevant communication connections 30 for monitoring purposes. If necessary, this information also can be defined on a terminal-specific basis.

If a connection of this type is established between TA and TB, and the data on this connection has to be recorded, then this operation is detected by the control system STE in the recording equipment because data arrives via the interface S0/S2, for example. In this case, the control equipment STE issues a control command, for example, via the CTI interface to the switching equipment PBX. This command has the effect of mirroring the connection 30 onto a connection 40 between a virtual terminal VT and the recording equipment AE. In this context, the duplication of data cannot be retraced on the communication connection 30. The communication data on the communication connection 30 arrives via path 40 and the interface S0/S2 at the recording equipment, where it is recorded on the hard disk HD. The recording equipment AE is preferably implemented as a PC that has a hard disk HD. However, it is also possible to use other peripheral devices on a personal computer for the purpose of recording communication data. For example, write-once or rewritable optical discs could be used. The communication network or data network could be a local-area network, for example, or even the World Wide Web.

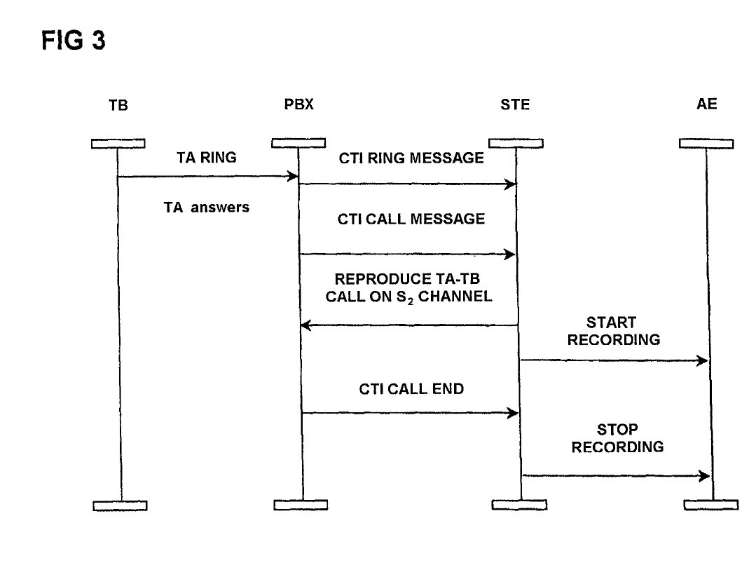

FIG. 3 shows a communication model that illustrates the recording operation, using the example of a recording method and the associated exchange of messages.

First, an incoming ringing signal from the user TB is detected in the switching equipment PBX. The switching equipment PBX sends a CTI ringing message to the control system STE. After user A answers, the switching equipment triggers a CTI call message to the control system STE via the CTI interface. In response to the call message, the control system causes the call between TA and TB to be reproduced on the S2 channel.

Finally, the control system instructs the recording equipment to start recording the call data or communication data. When the call between TA and TB has finished, the switching equipment PBX sends a CTI call end message to the control system, which then instructs the recording equipment to terminate the recording operation.

An analog approach is conceivable for the reproduction of recorded communication data via a terminal device. If applicable, before issuing the command to reproduce the call from TA to TB on the S2 channel, the control equipment STE can check whether the connection between TA and TB meets the criteria required for recording the communication data. This check may be based on terminal-specific or user-specific data, which is defined in advance for the connections to be monitored and is available for the control system STE to access.

With this type of system and method, it is particularly beneficial if control is undertaken entirely by the PC. This also eliminates the need for additional recording devices (e.g., tape recorder or locker). It also can be beneficial to implement a World Wide Web server on the PC, so that other PCs can access the recorded data via a LAN, an intranet or the Internet. The use of a PC increases the level of interference immunity and performance in comparison with state-of-the-art solutions.

Although the present invention has been described with reference to specific embodiments, those of skill in the art will recognize that changes may be made thereto without departing from the spirit and scope of the invention as set forth in the hereafter appended claims.

I claim as my invention:

1. A method for at least one of recording and reproducing communication data, the method comprising the steps of:
connecting a first user to a second user via a digital switching system using a communication connection; and
exchanging digital communication data from the communication connection via a digital interface between a digital recording system and the digital switching system.

2. A method for at least one of recording and reproducing communication data as claimed in claim 1, further comprising the step of:
pre-defining the communication connection.

3. A method for at least one of recording and reproducing communication data as claimed in claim 1, further comprising the step of:
controlling the digital switching system via the digital recording system.

4. A method for at least one of recording and reproducing communication data as claimed in claim 3, further comprising the step of:
establishing a separate CTI connection wherein the digital switching system exchanges control information with the digital recording system via the CTI connection.

5. A method for at least one of recording and reproducing communication data as claimed in claim 1, wherein the digital communication data is a digitized voice.

6. A system for at least one of recording and reproducing communication data, comprising:
a communication connection between a first user and a second user, wherein the first user and the second user can communicate digitally via the digital communication connection;
a digital switching system which provides the digital communication connection;
a digital recording system connected to the digital switching system via a digital data connection; and
primary resources for controlling the digital switching system and initiating the exchange of digital communication data between the digital recording system and the digital switching system.

7. A system for at least one of recording and reproducing communication data as claimed in claim 6, wherein the digital data connection includes an So.

8. A system for at least one of recording and reproducing communication data as claimed in claim 6, wherein the connection between the digital recording system and the digital switching system is a CTI connection.

9. A system for at least one of recording and reproducing communication data as claimed in claim 8, wherein the primary resources are located in the digital recording system and control the digital switching system via the CTI connection.

10. A system for at least one of recording and reproducing communication data as claimed in claim 6, wherein the digital recording system is a personal computer.

11. A system for at least one of recording and reproducing communication data as claimed in claim 10, wherein the personal computer is connected to a data network, and the at least one of recording and reproducing occurs via the data network.
